(19) United States
(12) Patent Application Publication
(10) Pub. No.: US 2007/0150824 A1
(43) Pub. Date: Jun. 28, 2007

(54) OSD controlling method for achieving user-definable menu

(75) Inventor: Zhong-Wu Tian, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,407

(22) Filed: Dec. 26, 2006

(30) Foreign Application Priority Data
Dec. 23, 2005 (TW) 94146345

(51) Int. Cl. G06F 3/00; G06F 17/00

(52) U.S. Cl. 715/764

(57) ABSTRACT

An exemplary on-screen display (OSD) controlling method for a display device is provided. The display device includes a micro-controller unit. The OSD controlling method includes: entering a menu ordering mode of an OSD menu of the display device; setting a new arrangement order of icons of the OSD menu, and generating an instruction including the new arrangement order; sending the instruction to the micro-controller unit; and the micro-controller unit changing the arrangement order of the icons of the OSD menu according to the instruction. The OSD controlling method includes an ordering step, and allows a user to customize the arrangement order of the OSD menu. Thus, the user can spend less time to select a desired icon. This results in convenient operation and high efficiency.

### BACKGROUND

1. Field of the Invention

The present invention relates to on-screen display (OSD) controlling methods for display devices, and particularly to an on-screen display controlling method for a display device which can achieve a user-definable menu.

2. General Background

In general, a monitor is a display device that is used with an apparatus such as a computer in order to show data generated by the computer. Most popular monitors can be classified as either CRT (Cathode Ray Tube) monitors or LCD (Liquid Crystal Display) monitors.

Some such monitors have an OSD function for displaying information relating to adjusting of display characteristics of video signal transmitted from the computer as well as information about the monitor itself. The OSD activated on the screen of the monitor can include a plurality of menus for altering information associated with a shape, a color, etc., of the display, or can include information about the video signals.

A monitor having such an OSD function includes a control unit for receiving a video signal output from a video card of a computer and for receiving horizontal and vertical synchronizing signals to discriminate a resolution, a key inputting unit for generating a control signal for controlling a monitor screen, an OSD generating unit for processing OSD data applied thereto from the control unit to generate an OSD, a memory for storing OSD data, and a power supply circuit for supplying electric power to the control unit, and the memory.

The key inputting unit includes a menu key for activating an OSD menu on a monitor screen, four directional keys, i.e., UP/DOWN/LEFT/RIGHT keys for moving a pointer indicated on the OSD menu to select a desired icon and/or adjusting the selected icon, and an end key for closing the OSD menu.

However, icons of the OSD menu are arranged in a fixed order, and users cannot customize the order of the icons of the OSD menu. Thus, users may spend much time to move the pointer to the desired icon. This results in inconvenient operation and wasted time.

Therefore, a new OSD controlling method that can overcome the above-described problems is desired.

### SUMMARY

In one preferred embodiment, an on-screen display (OSD) controlling method for a display device is provided. The display device includes a micro-controller unit. The OSD controlling method includes: entering a menu ordering mode of an OSD menu of the display device; setting a new arrangement order of icons of the OSD menu, and generating an instruction including the new arrangement order; sending the instruction to the micro-controller unit; and the micro-controller unit changing the arrangement order of the icons of the OSD menu according to the instruction.

Other advantages and novel features will become more apparent from the following detailed description when taken in conjunction with the accompanying drawings.

### BRIEF DESCRIPTION OF THE DRAWINGS

FIG. 1 is a flow chart of an on-screen display controlling method for a display device according to a first embodiment of the present invention.

FIG. 2 is a flow chart of an on-screen display controlling method for a display device according to a second embodiment of the present invention.

### DETAILED DESCRIPTION OF PREFERRED EMBODIMENTS

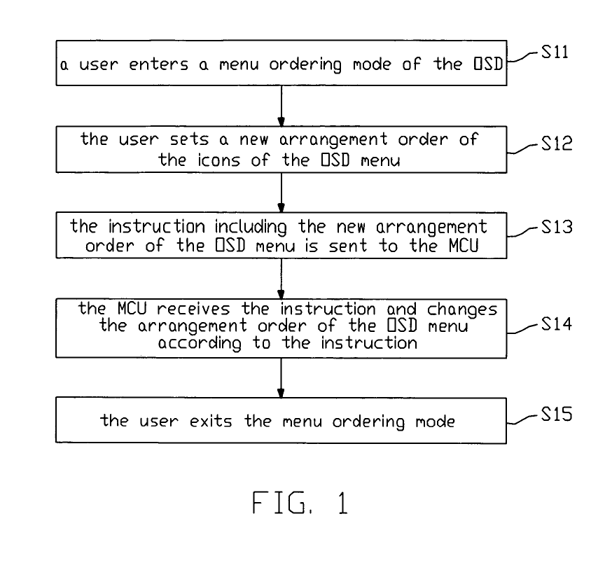

Referring to FIG. 1, this is a flow chart of an on-screen display (OSD) controlling method for a display device according to a first embodiment of the present invention. The display device includes a micro-controller unit (MCU), a key inputting unit, and a memory. The key inputting unit can be a plurality of push buttons or turn buttons. The memory can be an electrically erasable programmable read-only memory (EEPROM).

The OSD controlling method includes the following steps:

Step S11, a user enters a menu ordering mode of the OSD by operating an “ordering” button or selecting an “ordering” icon of the OSD menu. The OSD menu is stored in the memory, and includes a plurality of icons relating to display parameters of the display device, such as brightness, contrast ratio, color temperature, standard color, chroma, language, and so on.

Step S12, the user sets a new arrangement order of the icons of the OSD menu. The user sets the arrangement order according to his or her personal needs. The arrangement order of the icons of the OSD menu follows an order in which the icons are selected. For example, the OSD menu includes icons of “A, B, C, D, E” in turn. The user selects the icons C, E, B, A, and D in turn. Thus, the new arrangement order of the OSD menu is “C, E, B, A, D”. An instruction including the new arrangement order is generated.

Step S13, the instruction including the new arrangement order of the OSD menu is sent to the MCU.

Step 14, the MCU receives the instruction and changes the arrangement order of the OSD menu according to the instruction. Data of the new OSD menu is stored in the memory.

Step 15, the user exits the menu ordering mode by operating an “exit” button of the key inputting unit. After that, the OSD menu displayed on the display device has the new arrangement order which is set by the user.

In summary, the OSD controlling method includes an ordering step, and allows the user to customize the arrangement order of the OSD menu. Thus, the user can spend less time to select a desired icon. This results in convenient operation and high efficiency.

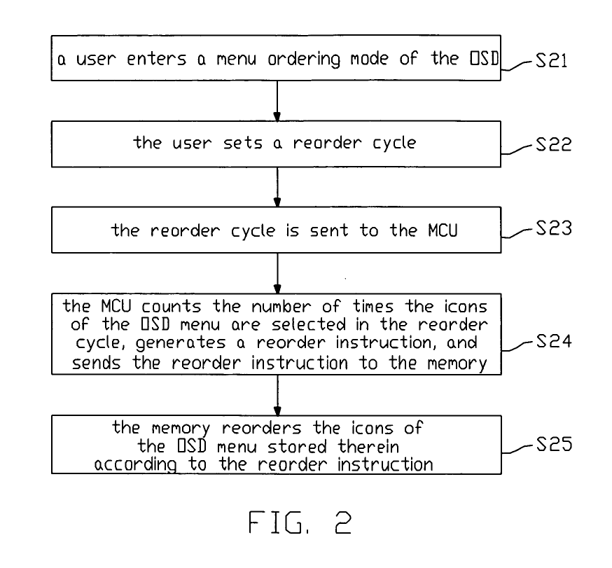

Referring to FIG. 2, this is a flow chart of an OSD controlling method for a display device according to a second embodiment of the present invention. The display device includes an MCU, a key inputting unit and a memory. The key inputting unit can be a plurality of push buttons or turn buttons. The memory can be an EEPROM.

The OSD controlling method includes the following steps:

Step S21, a user enters a menu ordering mode of the OSD by operating an “ordering” button or selecting an “ordering” icon of the OSD menu. The OSD menu includes a plurality of icons relating to display parameters of the display device, such as brightness, contrast ratio, color temperature, standard color, chroma, language, and so on.

Step S22, the user sets a reorder cycle. The reorder cycle can be in respect of a period such as a week or a month.

Step S23, the reorder cycle is sent to the MCU.

Step S24, the MCU receives the reorder cycle, counts the number of times the icons of the OSD menu are selected in the reorder cycle, and generates a reorder instruction when the reorder cycle is expired. The reorder instruction includes an arrangement order of the icons of the OSD menu, which arrangement order follows the number of times of selection of the icons in the reorder cycle. For example, the OSD menu includes icons of “A, B, C, D, E” in turn. In the reorder cycle, the user selects the icon “C” the most times, and selects the icon “D” the fewest times. Thus, in the reordered OSD menu, the icon “C” is arranged in a first position, and the icon “D” is arranged in a last position. The reorder instruction is sent to the memory.

Step S25, the memory receives the reorder instruction, and reorders the icons of the OSD menu stored therein according to the arrangement order of the reorder instruction.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An on-screen display (OSD) controlling method for a display device, the display device comprising a micro-controller unit, the OSD controlling method comprising:
entering a menu ordering mode of an OSD menu of the display device;
setting a new arrangement order of icons of the OSD menu, and generating an instruction including the new arrangement order;
sending the instruction to the micro-controller unit; and
the micro-controller unit changing the arrangement order of the icons of the OSD menu according to the instruction.

2. The OSD controlling method as claimed in claim 1, wherein the display device further comprises a key inputting unit.

3. The OSD controlling method as claimed in claim 2, wherein the key inputting unit comprises a plurality of buttons selected from the group consisting of a push button and a turn button.

4. The OSD controlling method as claimed in claim 3, wherein entering the menu ordering mode of the OSD menu is performed by operating an “ordering” button of the key inputting unit.

5. The OSD controlling method as claimed in claim 1, wherein entering the menu ordering mode of the OSD menu is performed by selecting an “ordering” icon of the OSD menu.

6. The OSD controlling method as claimed in claim 1, wherein icons of the OSD menu relate to display parameters of the display device, and the display parameters are selected from the group consisting of brightness, contrast ratio, color temperature, standard color, chroma, and language.

7. The OSD controlling method as claimed in claim 1, wherein the display device further comprises a memory, and the OSD menu is stored in the memory.

8. The OSD controlling method as claimed in claim 7, wherein the memory is an electrically erasable programmable read-only memory.

9. An on-screen display (OSD) controlling method for a display device, the display device comprising a micro-controller unit and a memory having an OSD menu stored therein, the OSD controlling method comprising:
entering a menu ordering mode of the OSD menu of the display device;
setting a reorder cycle, the reorder cycle comprising a time period;
sending the reorder cycle to the micro-controller unit;
the micro-controller unit receiving the reorder cycle, counting a number of times that each of icons of the OSD menu are selected in the reorder cycle to obtain a counting result, generating a reorder instruction according to the counting result, and sending the reorder instruction to the memory; and
the memory reordering the icons of the OSD menu according to the reorder instruction.

10. The OSD controlling method as claimed in claim 9, wherein the display device further comprises a key inputting unit.

11. The OSD controlling method as claimed in claim 10, wherein the key inputting unit comprises a plurality of buttons selected from the group consisting of a push buttons and a turn button.

12. The OSD controlling method as claimed in claim 11, wherein entering the menu ordering mode of the OSD menu is performed by operating an “ordering” button of the key inputting unit.

13. The OSD controlling method as claimed in claim 9, wherein entering the menu ordering mode of the OSD menu is performed by selecting an “ordering” icon of the OSD menu.

14. The OSD controlling method as claimed in claim 9, wherein icons of the OSD menu relate to display parameters of the display device, and the display parameters are selected from the group consisting of brightness, contrast ratio, color temperature, standard color, chroma, and language.

15. The OSD controlling method as claimed in claim 9, wherein the memory is an electrically erasable programmable read-only memory.
